(19) United States
(12) Patent Application Publication
(10) Pub. No.: US 2012/0194854 A1
(43) Pub. Date: Aug. 2, 2012

(54) AUTOMATIC PRINTER SETUP SYSTEM

(75) Inventors: Shiau Khoon Tang, Singapore (SG); Kai Leong Wong, Singapore (SG)

(73) Assignee: DELL PRODUCTS L.P., Round Rock, TX (US)

(21) Appl. No.: 13/018,918

(22) Filed: Feb. 1, 2011

(51) Int. Cl. G06F 15/00

(52) U.S. Cl. 358/1.15

(57) ABSTRACT

A printer setup system includes a plurality of printers coupled to a network that each display a respective printer setup code. A printer database is coupled to the network and includes printer setup information for each printer. An information handling system (IHS) including a camera is coupled to the printer database through the network. The IHS includes a decoding engine to receive an image of a first printer setup code displayed by a first printer from the camera and decode the first printer setup code to determine printer identification information for the first printer, and a printer setup engine to access the printer database, use the printer identification information for the first printer to retrieve printer setup information for the first printer, and provide the printer setup information for the first printer on the IHS such that the IHS is operable to print on a printing medium using the first printer.

### BACKGROUND

The present disclosure relates generally to information handling systems (IHSs), and more particularly to an automatic printers setup system for IHSs.

As the value and use of information continues to increase, individuals and businesses seek additional ways to process and store information. One option is an IHS. An IHS generally processes, compiles, stores, and/or communicates information or data for business, personal, or other purposes. Because technology and information handling needs and requirements may vary between different applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

It is often desirable to connect IHSs to printers in order to print out an electronic document that may be stored on the IHS on a physical printing medium (e.g., paper.) However, connecting an IHS to a printer can raise a number of issues. For example, an entity may provide several printers on a network and it may be difficult to identify a particular printer and determine its associated printer driver that allows the printer to be used by an IHS. This is particularly true when a user with a mobile IHS visits a location where they do not typically use their mobile IHS and therefore have not previously connected to any printers. In such situations, the user is conventionally required to determine a name and/or address of the printer and then provide that information to printer setup software on the mobile IHS in order to set up the printer. This typically requires that the user search for and copy down such details and then type those details into the printer setup software before the mobile IHS can connect to and use the printer, which consumes time and can be frustrating for the user.

Accordingly, it would be desirable to provide an improved printer setup system.

### SUMMARY

According to one embodiment, a printer setup system includes a network, a plurality of printers coupled to the network, wherein each of the plurality of printers displays a respective printer setup code, a printer database coupled to the network and including printer setup information for each of the plurality of printers, an information handling system (IHS) including a camera and coupled to the printer database through the network, a decoding engine located on the IHS and operable to receive an image of a first printer setup code displayed by a first printer from the camera and decode the first printer setup code to determine printer identification information for the first printer, and a printer setup engine located on the IHS and operable to access the printer database, use the printer identification information for the first printer to retrieve printer setup information for the first printer, and provide the printer setup information for the first printer on the IHS such that the IHS is operable to print on a printing medium using the first printer.

### BRIEF DESCRIPTION OF THE DRAWINGS

FIG. 1 is a schematic view illustrating an embodiment of an information handling system.

FIG. 2 is a perspective view illustrating an embodiment of a printer displaying a printer setup code.

FIG. 3 is a front view illustrating an embodiment of the printer setup code displayed by the printer of FIG. 2.

FIG. 4 is a perspective view illustrating an embodiment of a mobile IHS.

FIG. 5 is a schematic view illustrating an embodiment of a user IHS.

FIG. 6 schematic view illustrating an embodiment of a networked system.

FIG. 7 is a flow chart illustrating an embodiment of a method for printer setup on an IHS.

### DETAILED DESCRIPTION

For purposes of this disclosure, an IHS may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an IHS may be a personal computer, a PDA, a consumer electronic device, a display device or monitor, a network server or storage device, a switch router or other network communication device, or any other suitable device and may vary in size, shape, performance, functionality, and price. The IHS may include memory, one or more processing resources such as a central processing unit (CPU) or hardware or software control logic. Additional components of the IHS may include one or more storage devices, one or more communications ports for communicating with external devices as well as various input and output (I/O) devices, such as a keyboard, a mouse, and a video display. The IHS may also include one or more buses operable to transmit communications between the various hardware components.

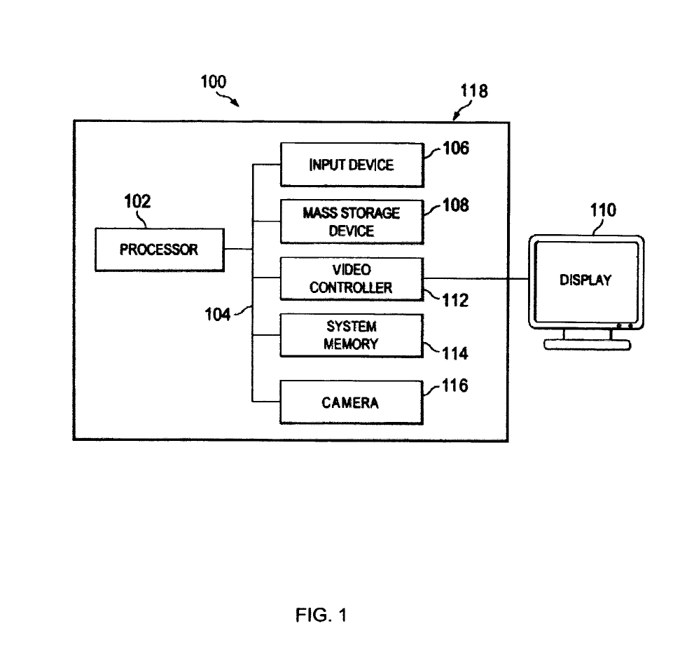

In one embodiment, IHS 100, FIG. 1, includes a processor 102, which is connected to a bus 104. Bus 104 serves as a connection between processor 102 and other components of IHS 100. An input device 106 is coupled to processor 102 to provide input to processor 102. Examples of input devices may include keyboards, touchscreens, pointing devices such as mouses, trackballs, and trackpads, and/or a variety of other input devices known in the art. Programs and data are stored on a mass storage device 108, which is coupled to processor 102. Examples of mass storage devices may include hard discs, optical disks, magneto-optical discs, solid-state storage devices, and/or a variety other mass storage devices known in the art. IHS 100 further includes a display 110, which is coupled to processor 102 by a video controller 112. A system memory 114 is coupled to processor 102 to provide the processor with fast storage to facilitate execution of computer programs by processor 102. Examples of system memory may include random access memory (RAM) devices such as dynamic RAM (DRAM), synchronous DRAM (SDRAM), solid state memory devices, and/or a variety of other memory devices known in the art. A camera 116 is coupled to the processor to provide images and/or video to components of the IHS 100. In an embodiment, a chassis 118 houses some or all of the components of IHS 100. It should be understood that other buses and intermediate circuits can be deployed between the components described above and processor 102 to facilitate interconnection between the components and the processor 102.

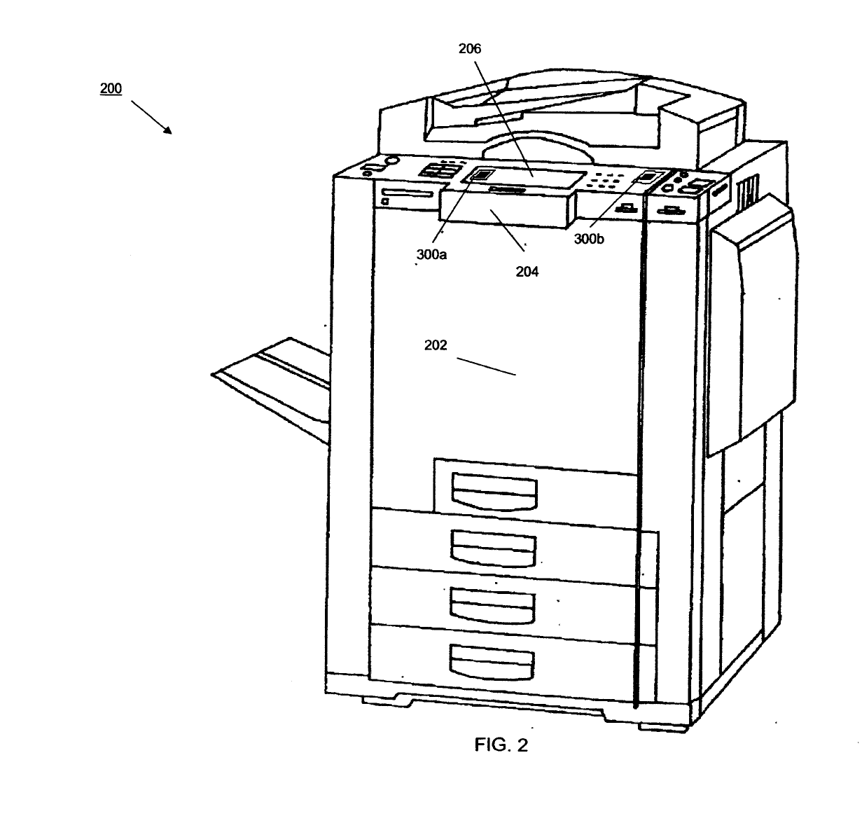

Referring now to FIG. 2, a printer 200 is illustrated. The printer 200 includes a base 202 having a control panel 204 that includes an electronic display 206. In an embodiment, the printer 200 may be the IHS 100 discussed above with reference to FIG. 1 and may include some or all of the components of the IHS 100. In an embodiment, the printer 200 is a networkable printer known in the art that includes hardware for coupling the printer to one or more information handling systems through a network, and the printer 200 is operable to print to a printing medium (e.g., paper that is stored in the printer 200 illustrated in FIG. 2), copy documents, fax documents, and/or perform a variety of other printer functions known in the art. In an embodiment, the electronic display 206 may be a conventional electronic display, an electronic-paper (E-Paper) display, and/or a variety of other displays known in the art.

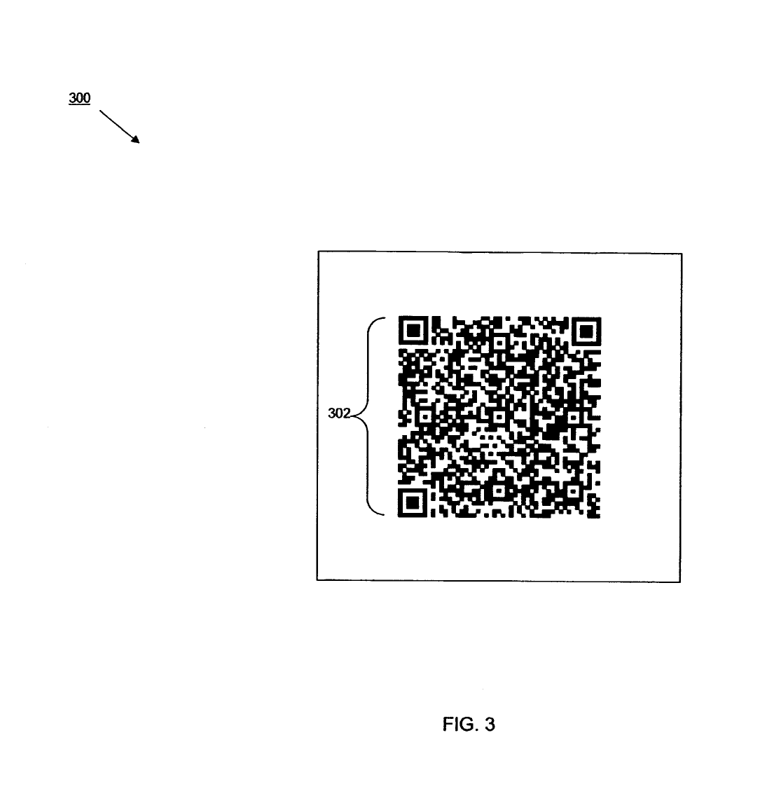

Referring now to FIGS. 2 and 3, the printer 200 may display a printer setup code 300. In one embodiment, the printer setup code 300a is displayed on the electronic display 206 of the printer 200. For example, the electronic display 206 may be a conventional electronic display that includes a resolution and/or contrast level that is sufficient to display the printer setup code 300a in a manner that allows the method 700 to be practiced as is discussed in further detail below. In another example, the electronic display 206 may be an E-Paper display that displays the printer setup code 300a. One of skill in the art will recognize that displaying the printer setup code 300a on an E-Paper display allows the display of the printer setup code 300a without the need to supply power to the electronic display 206 unless the information (e.g., the printer setup code 300a) on the electronic display 206 changes. Furthermore, with the printer 200 coupled to a network, a management IHS may be used to change information about the printer 200 through the network, and that information may be updated and displayed using the printer setup code 300a displayed on the electronic display 206. In another embodiment, a printer setup code 300b is displayed on a physical medium that is attached to the printer control panel 204 of the printer 200, such as on an adhesive label or a printing medium that is attached to the printer control panel 204. While the printer setup codes 300a and 300b are illustrated in FIG. 2 as both displayed by the printer 200, one of skill in the art will recognize that only one printer setup code need be displayed (e.g., only the printer setup code 300a on the electronic display 206 or only the printer setup code 300b on the physical medium.) In another embodiment, the printer 200 may be operable to print the printer setup code 300 on a printing medium (e.g., a piece of paper.) For example, the printer 200 may include a built-in information page on the printer settings that can print the printer setup code 300 on a printing medium. FIG. 3 illustrates one embodiment of the printer setup code 300 (which may be either of the printer setup codes 300a or 300b. In the embodiment illustrated in FIG. 3, the printer setup code 300 includes a two-dimensional bar code 302 such as, for example, a Quick Response (QR) code having a plurality of black modules arranged in a square pattern on a white background. Printer setup code 300 such as the QR code 302 illustrated in FIG. 3 may encode 7,089 numeric characters, 4,296 alphanumeric characters, or 2,953 binary bytes. In an embodiment, the printer setup code 300 may encode a name of the printer 200 and/or network information about the printer 200 such as, for example, a Universal Naming Convention (UNC) name for the printer 200, a server queue for the printer 200, an Internet Protocol (IP) address for the printer 200, and/or a variety of other printer network information known in the art.

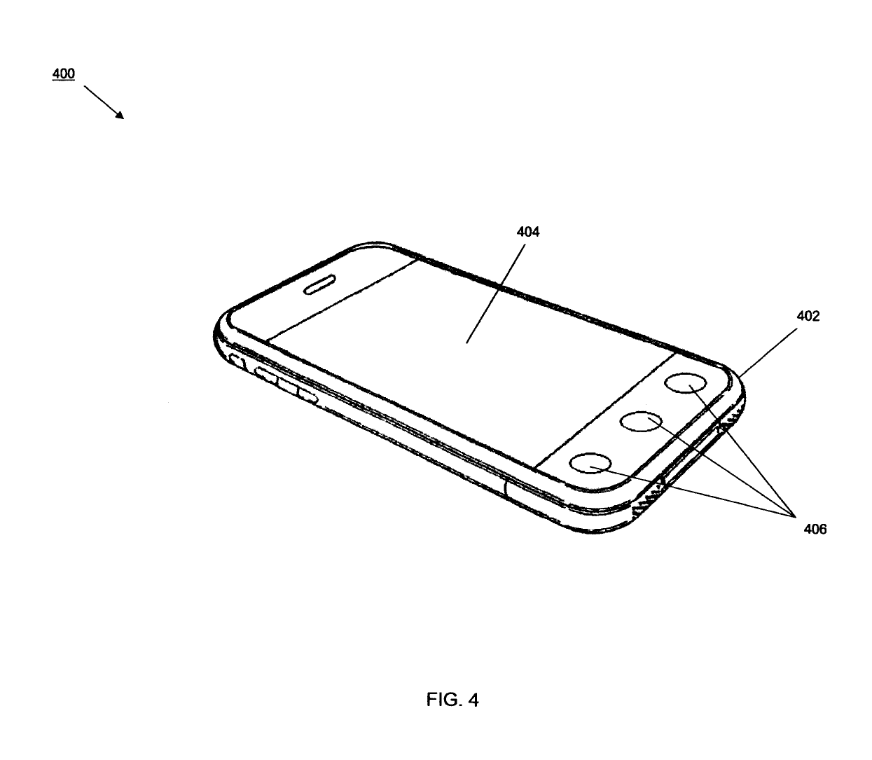

Referring now to FIG. 4, a mobile IHS 400 is illustrated. In an embodiment, the mobile IHS 400 may be the IHS 100, described above with reference to FIG. 1. The mobile IHS 400 includes a chassis 402 housing a display screen 404 and including a plurality of input buttons 406. The mobile IHS 400 also includes a camera (not illustrated) that may be located on the chassis 402 opposite the display screen 404. While one of skill in the art will recognize that the mobile IHS 400 illustrated in FIG. 4 is a mobile phone known in the art, the present disclosure is not limited to this embodiment, and mobile IHSs such as, for example, notebook/laptop computer, tablet/slate computers, and/or a variety of other mobile IHSs known in the art are meant to fall within the scope of the present disclosure.

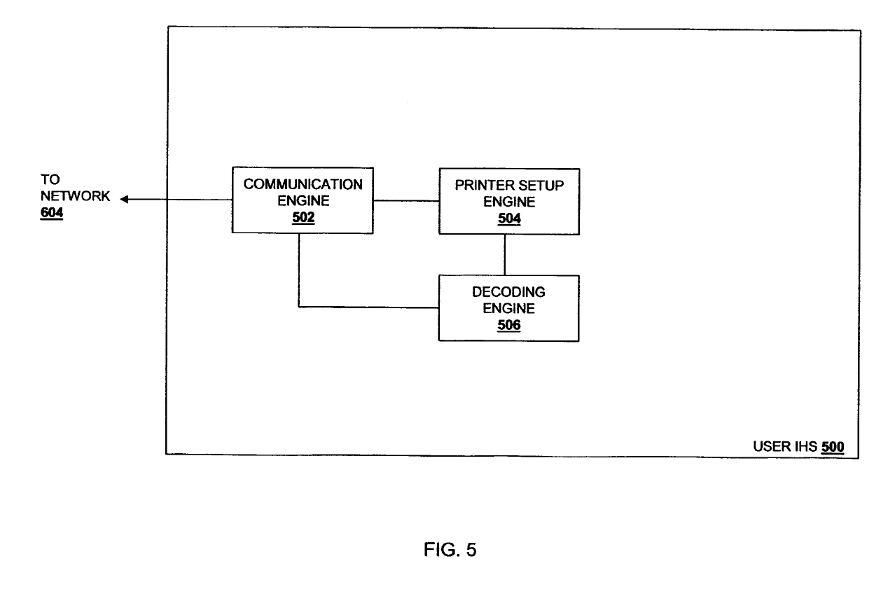

Referring now to FIG. 5, a user IHS 500 is illustrated. In an embodiment, the user IHS 500 may be the IHS 100, described above with reference to FIG. 1, or the mobile IHS 400, described above with reference to FIG. 4. The user IHS 500 includes a communications engine 502 that is coupled to a network 604, described in further detail below, and each of a printer setup engine 504 and a decoding engine 506. The communications engine 502 may be software that is stored on a non-transitory computer-readable medium and includes instructions that, when executed by a processor (e.g., the processor 102), allow the communications engine 502 to communicate information between the network 604 and the printer setup engine 504 and the decoding engine 506, as is described in further detail below. The printer setup engine 504 is coupled to the decoding engine 506. The printer setup engine 504 may be software that is stored on a non-transitory computer-readable medium and includes instructions that, when executed by a processor (e.g., the processor 102), allow the printer setup engine 504 to send and/or receive information from the communication engine 502 and the decoding engine 506, use that information to retrieve printer setup information, and use the printer setup information to setup a printer (e.g., the printer 200) for use by the user IHS 500, as is described in further detail below. The decoding engine 506 may be software that is stored on a non-transitory computer-readable medium and includes instructions that, when executed by a processor (e.g., the processor 102), allow the decoding engine 506 to receive a printer setup code (e.g., the printer setup code 300) through the communications engine 502, decode that code to determine printer identification information, and send that printer identification information to the printer setup engine 504 as is described in further detail below.

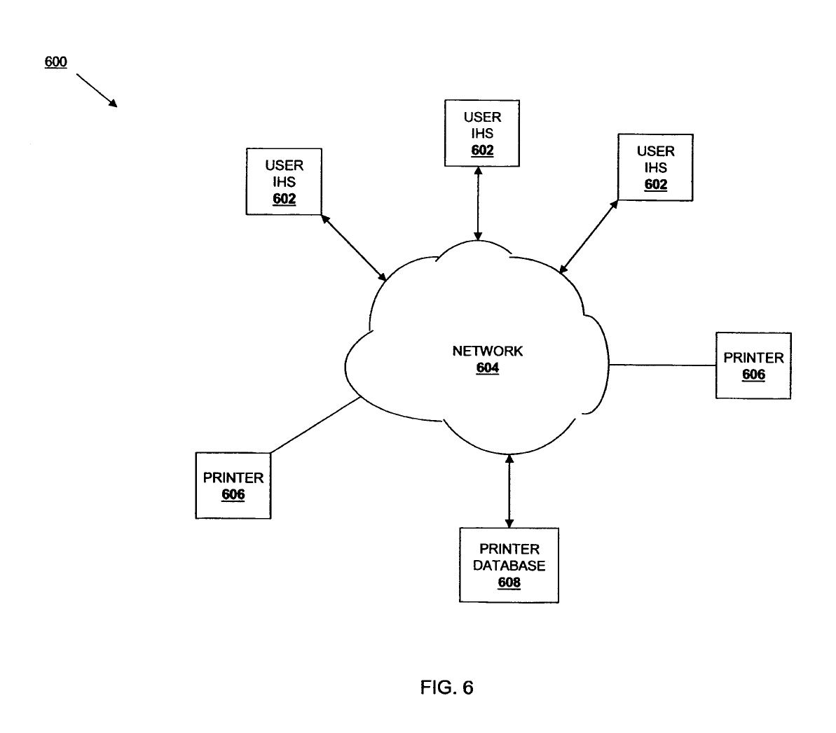

Referring now to FIG. 6, a networked system 600 is illustrated. The networked system 600 includes one or more user IHSs 602, which may be the IHS 100 described above with reference to FIG. 1, the mobile IHS 400 described above with reference to FIG. 4, and/or the user IHS 500 described above with reference to FIG. 5. The one or more user IHSs 602 are coupled to a network 604 which is coupled to one or more printers 606, each which may be substantially similar to the printer 200 described above with reference to FIG. 2, and a printer database 608. In the embodiment described below, the network 604 is an intranet. However, the network 604 may a variety of networks known in the art without departing from the scope of the present disclosure. The printer database 608 is a database that stores printer setup information such as, for example, one or more printer drivers that are each operable to be used by the printer setup engine 504 to setup a printer for use by the user IHSs 602.

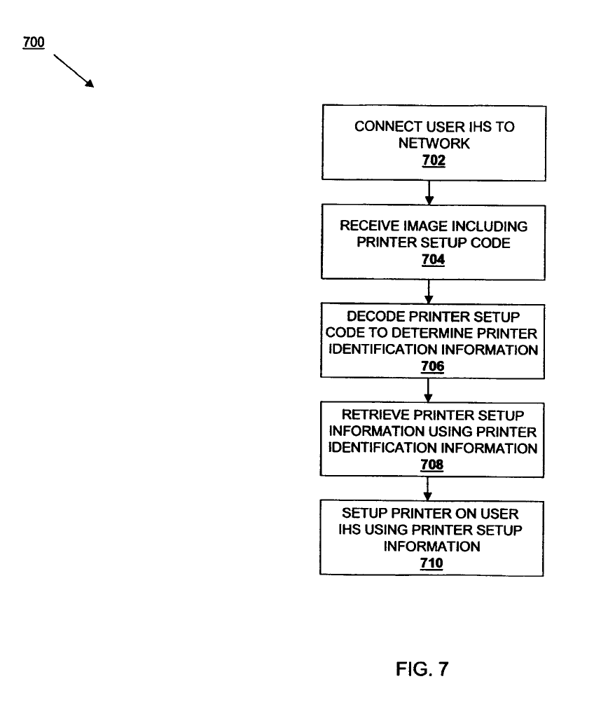

Referring now to FIGS. 2, 3, 4, 5, 6, and 7, a method 700 for printer setup on an IHS is illustrated. The method 700 begins at block 702 where a user IHS is connected to a network. In an embodiment, one of the user IHSs 602 is connected to the network 604 using methods known in the art. For example, a user of the mobile IHS 400 may be in a location that includes the intranet network 604 having the plurality of printers 606, and the user may want to print a document that is stored on the mobile IHS 400 or use some other functionality of one of the printers 606. The user may use the mobile IHS 400 to wirelessly connect the mobile IHS 400 to the intranet network 604 using method know in the art (e.g., providing a network name and password to log into the intranet network) such that mobile IHS 400 becomes one of the user IHSs 602 connected to the network 604 as illustrated in FIG. 6.

The method 700 then proceeds to block 704 where an image including a printer setup code is received. In an embodiment, each of the printers 606 may be the printer 200 displaying the printer setup code 300. The user may use the camera (e.g., the camera 116 described above with reference to FIG. 1) on the mobile IHS 400 to take an image of the printer setup code 300 that is displayed by the printer 200 that the user wishes to use. In an embodiment, the electronic display 206 on the printer 200 includes a resolution and contrast level that is sufficient to allow decoding of an image of the printer setup code 300, discussed in further detail below, and the image taken by the mobile IHS 400 is of the printer setup code 300a displayed on the electronic display 206. In another embodiment, the image taken by the mobile IHS 400 is of the printer setup code 300b displayed on the physical medium. The image taken by the camera on the mobile IHS 400 is sent by the camera (e.g., through the communications engine 502) and received by the decoding engine 506.

The method 700 then proceeds to block 706 where the printer setup code is decoded to determine printer identification information. Upon receiving the image of the printer setup code 300 taken by the camera on the mobile IHS 400, the decoding engine 506 is operable to detect the printer setup code 300 in the image and decode the printer setup code 300 to extract printer identification information that may include a name for the printer 606 and/or printer network information about the printer 606 such as, for example, a UNC name for the printer 606, a server queue for the printer 606, an IP address for the printer 606, and/or a variety of other printer network information known in the art. The method 700 then proceeds to block 708 where printer setup information is retrieved using the printer identification information. The printer identification information extracted from the image of the printer setup code 300 by decoding the printer setup code 300 may then be sent by the decoding engine 506 to the printer setup engine 504. The printer setup engine 504 may then use the printer identification information to access the printer database 608 (e.g., using the communication engine 502) and retrieve printer setup information stored in the printer database 608. For example, the printer identification information may include a name of the printer 606 and an IP address of the printer 606, and the printer setup engine 504 may use the name of the printer 606 and the IP address of the printer 606 to determine the appropriate printer driver for the printer 606 that is stored in the printer database 508. That printer driver for the printer 606 is then retrieved by the printer setup engine 504 (e.g., through the communications engine 502).

The method 700 then proceeds to block 710 where a printer is setup on a user IHS using the printer setup information. The printer setup engine 504 uses the printer setup information (e.g., the printer driver for the printer 606) to setup the printer 606 for use by the mobile IHS 400 such that the mobile IHS 400 is operable to use the printer 606 to print on a printing medium and/or use other functionality of the printer 606. The user may then use the mobile IHS 400 to print documents and/or other materials that are stored on the mobile IHS 400 to a printing medium using the printer 200.

Thus, a system and method are provided that allow a user with a mobile device to connect to a network that includes a plurality of printers and simply take an image of a printer setup code that is displayed by the printer in order to have that printer automatically set up to be used by the mobile IHS. Such a system and method greatly simplifies the setup of a printer on a mobile IHS, as instead of having to determine and remember a printer name and/or IP address and then provide that printer name and IP address to a setup program as is required in conventional system, the user needs only to take an image using a camera that is included on the IHS that the user wants to use the printer with.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A printer setup system, comprising:
a network;
a plurality of printers coupled to the network, wherein each of the plurality of printers displays a respective printer setup code;
a printer database coupled to the network and including printer setup information for each of the plurality of printers;
an information handling system (IHS) including a camera and coupled to the printer database through the network;
a decoding engine located on the IHS and operable to receive an image of a first printer setup code displayed by a first printer from the camera and decode the first printer setup code to determine printer identification information for the first printer; and
a printer setup engine located on the IHS and operable to access the printer database, use the printer identification information for the first printer to retrieve printer setup information for the first printer, and provide the printer setup information for the first printer on the IHS such that the IHS is operable to print on a printing medium using the first printer.

2. The system of claim 1, wherein the first printer setup code includes a two-dimensional bar code.

3. The system of claim 1, wherein at least one of the plurality of printers displays the respective printer setup code using an electronic display.

4. The system of claim 1, wherein at least one of the plurality of printers displays the respective printer setup code on a physical medium attached to the at least one printer.

5. The system of claim 1, wherein at least one of the plurality of printers displays the respective printer setup code by printing the respective printer setup code on a printing medium.

6. The system of claim 1, wherein the printer identification information for the first printer that is determined by decoding the first printer setup code comprises a printer name and a printer address.

7. The system of claim 1, wherein the IHS is a mobile IHS that is wirelessly connected to the network.

8. The system of claim 1, wherein the printer setup information for the first printer includes a printer driver for the first printer.

9. An information handling system, comprising:
a processor;
a camera coupled to the processor;
a non-transitory, computer readable medium coupled to the processor;
a decoding engine located on the non-transitory, computer readable medium and including computer readable instructions that, when executed by the processor, receive an image of a first printer setup code displayed by a first printer from the camera and decode the first printer setup code to determine printer identification information for the first printer; and
a printer setup engine located on the non-transitory, computer readable medium and including computer readable instructions that, when executed by the processor, access a printer database through a network, use the printer identification information for the first printer to retrieve printer setup information for the first printer, and use the printer setup information to send instructions to the first printer to print on a printing medium.

10. The system of claim 9, wherein the first printer setup code includes a two-dimensional bar code.

11. The system of claim 9, wherein the first printer setup code is displayed on an electronic display.

12. The system of claim 9, wherein the first printer setup code is displayed on a physical medium attached to the first printer.

13. The system of claim 9, wherein the first printer setup code is displayed on a printing medium printed by the first printer.

14. The system of claim 9, wherein the printer identification information for the first printer that is determined by decoding the first printer setup code comprises a printer name and a printer address.

15. The system of claim 9, wherein the IHS is a mobile IHS that is wirelessly connected to the network.

16. The system of claim 9, wherein the printer setup information for the first printer includes a printer driver for the first printer.

17. A method for printer setup on an information handling system (IHS), comprising:
connecting the IHS to a network;
receiving an image on the IHS of a first printer setup code displayed by a first printer;
decoding the first printer setup code to determine printer identification information for the first printer;
retrieving printer setup information from a printer database by the IHS over the network using the printer identification information for the first printer; and
setting up the first printer on the IHS using the printer setup information for the first printer.

18. The method of claim 17, further comprising:
sending instructions by the IHS to the first printer over the network to print on a printing medium.

19. The method of claim 17, wherein the decoding the first printer setup code to determine printer identification information for the first printer includes decoding a two-dimensional bar code to determine a printer name and an printer address for the first printer.

20. The method of claim 17, wherein the retrieving printer setup information from the printer database includes retrieving a printer driver for the first printer.
